(19) United States
(12) Patent Application Publication
(10) Pub. No.: US 2008/0223976 A1
(43) Pub. Date: Sep. 18, 2008

(54) Space vehicle launch system

(76) Inventor: Robert Stephen Turner, Sterling Heights, MI (US)

Correspondence Address: Robert S. Turner, 35809 Malibu Dr., Sterling Heights, MI, 48312, US

(21) Appl. No.: 11/717,212

(22) Filed: Mar. 13, 2007

(51) Int. Cl. B64D 5/00

(52) U.S. Cl. 244/3

(57) ABSTRACT

A space vehicle launch system is proposed which utilizes a vacuum filled lighter than air vessel to lift a rocket powered vehicle to a high altitude where the vehicle can easily blast into outer space. The main advantages of this system are that, first, the rocket would not need to carry a large mass of fuel, and, therefore, this system would be much safer than the state of the art. Second, the vehicle would be lifted slowly through the atmosphere, and would not suffer any damage due to abrupt acceleration or air friction.

### Background

1. Field of Invention

This invention relates to space launch vehicles, and more particularly to vehicles which do not use a rocket as a means of boosting through the earth's atmosphere.

2. Description of Prior Art

A vehicle in outer space, near the earth's surface, has a great deal of gravitational potential energy relative to the earth's surface. A great deal of energy is, therefore, required to launch such a vehicle, and the launch system must provide this energy. Several launch systems have been proposed, and these can be grouped into three categories: rocket powered launch systems, airplane launch systems, and airship launch systems. Each of these categories is analyzed below.

A rocket powered launch system uses a rocket to blast the vehicle into outer space directly from the earth's surface. This system has several inherent problems.

The first that this system is expensive. Rocket engines cost a lot of money, and are generally not reusable.

The next problem is that rocket powered systems cause a great deal of vehicular acceleration, and this could cause injury to personnel aboard the vehicle, as well as, damage to the vehicle itself.

Another problem is that a rocket powered launch systems must blast through the atmosphere at a high speed, and the resulting air drag could cause damage to the vehicle.

The main problem is that rocket powered launch systems must carry a huge mass of fuel for energy, and this fuel could get out of control and explode.

An airplane launch system uses an airplane to lift a rocket powered vehicle to an altitude from which the vehicle can blast into outer space.

The main problem this type of system is that the maximum altitude that an airplane can fly is limited due to the lack of air at altitude. The space vehicle would still need to carry a great deal of fuel for energy, and would, therefore, have similar problems as those associated with rocket powered launch systems. An airship launch system uses a gas filled airship to lift a rocket power vehicle to an altitude from which the vehicle can blast into outer space.

A gas filled airship, like an airplane, can not fly to an altitude where there is little air, so this type of system has the same problems as an airplane launch system.

### OBJECTS AND ADVANTAGES

In this patent application, a launch system is proposed which utilizes a lighter than air vessel as a means of lifting a rocket powered space vehicle to a sufficient altitude for an easy launch into outer space. The LTA vessel is comprised of a vacuum container, instead of a gas filled container. A vacuum is lighter than air, and is lighter than any gas. A vacuum container could, therefore, float to a higher altitude than a gas filled container. This system has many advantages over the state of the art. Some of these are listed below.

The first advantage is that the vehicle would not have to accelerate fast while it is gaining altitude. A vehicle using this system would be lifted through the atmosphere, slowly, to an altitude where there is little air. This would prevent personal injury and vehicle damage caused by abrupt acceleration.

The next advantage is that the vehicle would not have to blast through the atmosphere at high speeds, and, therefore, the vehicle would not encounter any vehicle damage due to air friction.

The main advantage is that this launch system would not need to carry a large amount of fuel. The potential energy would be stored in the vacuum container. The vehicle would float to a high altitude, and then be blasted into space with a small amount of fuel.

### DRAWING FIGURES

FIG. 1 shows the proposed space vehicle launch system.

FIG. 2 shows the proposed launch system along with a launch fixture.

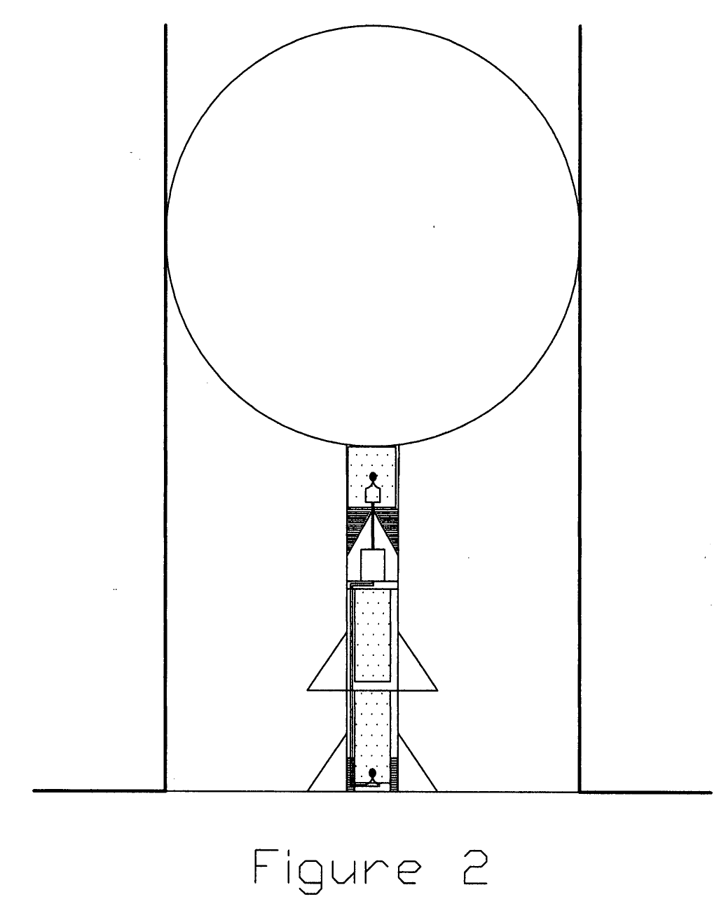

### REFERENCE NUMERALS IN DRAWINGS

1 The vacuum container
2 A black powder charge
3 A bracket which connects the vacuum container to the connector tube.
4 An igniter
5 The connector tube
6 Protective wadding
7 The payload
8 The control computer
9 The rocket
10 The second stage engine
11 The first stage engine
12 An igniter
13 A Weight
14 A Weight

### DESCRIPTION

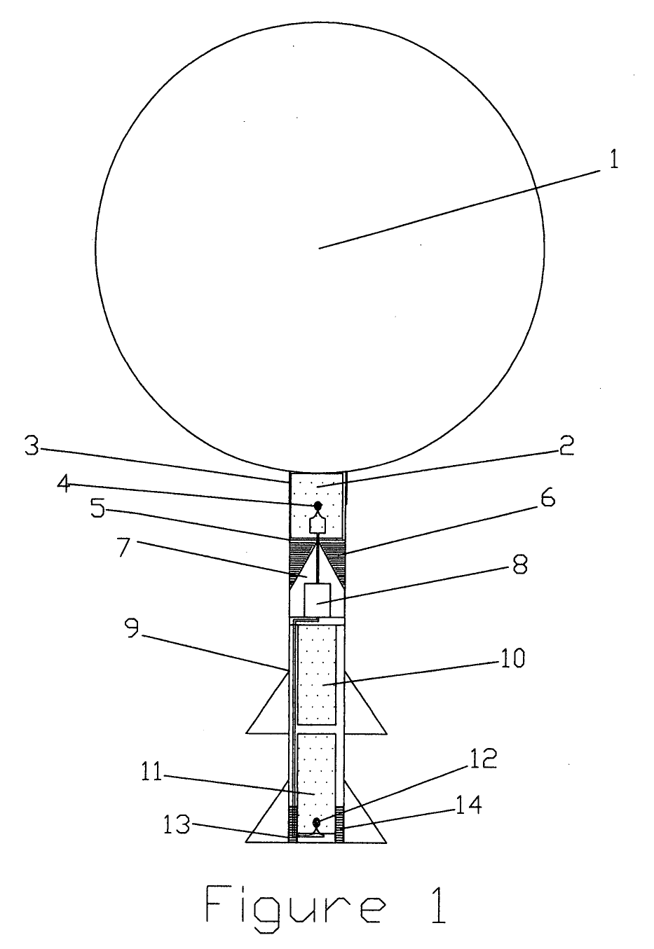

This invention, FIG. 1, is composed of several components. A detailed description of the structure of each component is given below.

The vacuum container 1 is typically spherical in shape, and is typically made of titanium. This sphere is typically welded together in sections, and the diameter is large enough so that the density of the overall space vehicle launch system is equal to the density of the air at the desired blast altitude.

The rocket 9 is a typical multistage rocket. Only two stages are shown in the figure. However, the rocket would have as many stages as would be needed to launch a payload 7 from the desired blast altitude to outer space.

The tube 5 is typically made of cardboard, and is glued to the bracket 4 at one end, and to the rocket's nose cone at the other end.

The bracket 3 is typically made of aluminum, and is typically welded to the sphere.

The charge 2 is a typical black powder charge that is just large enough to rupture the tube and jettison the sphere.

The wadding 6 is typical flame resistant, recovery wadding.

The igniters 4, 12 are typical copper model rocket igniters.

The rocket engines 10, 11 are typical solid rocket boosters with zero ejection charge delays.

The control computer 8 is typically a microprocessor based system which employs a pressure transducer. The computer is typically powered by a battery.

The weights 13, 14 are typically pieces of iron, and typically weigh a total of one-half the weight of the rocket.

### Operation

The operation of each component of the proposed space vehicle launch system, shown in FIG. 1, is explained below. A typical launch sequence will be described.

At launch time, the launch system is released from the launch fixture, and the vacuum container, 1 which is lighter than air, lifts the rocket 9 skyward. The launch system will float to an altitude where the air density is equal to the mean density of the launch system. This is the desired blast altitude.

The control computer 8 detects when the launch system is at its blast altitude by means of a pressure transducer.

The control computer then fires the black power charge 2, by means of igniter 4, which ruptures the tube 5, and jettisons the vacuum container 1.

The wadding 6 protects the nose cone from flame during the jettison.

After a short delay, following the jettison, the control computer 8 ignites the first stage engine 11 by means of igniter 12.

When the first stage engine burns out, its ejection charge automatically fires which jettisons the first stage and ignites the second stage engine 10. This process continues until all of the stages are burned out, and the payload 7 is in outer space.

The weights 13, 14 cause the rocket to orient itself vertically following the jettison of the sphere.

### Summary, Ramifications, Scope

In this invention, a space vehicle launch system is proposed which utilizes a lighter than air vacuum chamber to lift a rocket powered vehicle to a launch altitude where the vehicle can easily blast into outer space. Some of the advantages of this system are that, first, the vehicle would be lifted slowly through the atmosphere, and would not suffer any damage due to abrupt acceleration or air friction, and, second, the rocket would not need to carry a huge mass of fuel.

The above description contains many specifications, but these should not be construed as limitations on the scope of this invention. These specifications are exemplifications of one, preferred, embodiment. Other embodiments are possible. Accordingly, the scope of this invention should be determined, not by the embodiment illustrated, but by the appended claims and their legal equivalents.

What is claimed is:

1. A space vehicle launch system comprised of a lighter than air vessel and a rocket powered vehicle.

2. The launch system of claim 1 wherein said vessel provides the means for lifting said vehicle to a blast altitude within a planet's atmosphere.

3. The launch system of claim 1 wherein said vessel is a rigid walled container which is capable of holding a vacuum.

4. The launch system of claim 1 wherein said vessel is evacuated of all gasses.

5. The launch system of claim 1 wherein said vessel is connected to said rocket powered vehicle.

6. The launch system of claim 1 wherein said vehicle is a spacecraft.

7. The launch system of claim 1 wherein said vehicle has the capability of reaching outer space when ignited at a blast altitude within a planet's atmosphere.
